(19) United States
(12) Patent Application Publication
(10) Pub. No.: US 2010/0153134 A1
(43) Pub. Date: Jun. 17, 2010

(54) National Health Information and Electronic Medical Record System and Method

(75) Inventor: Robert Daniel Claud, III, Chicago, IL (US)

Correspondence Address: BANNER & WITCOFF, LTD., TEN SOUTH WACKER DRIVE, SUITE 3000, CHICAGO, IL, 60606, US

(73) Assignee: eCapable, Inc., Chicago, IL (US)

(21) Appl. No.: 12/507,641

(22) Filed: Jul. 22, 2009

Related U.S. Application Data
(63) Continuation-in-part of application No. 11/669,635, filed on Jan. 31, 2007.
Application No. 11/669,635 is a continuation-in-part of application No. 11/361,764, filed on Feb. 24, 2006, now abandoned.
Application No. 11/361,764 is a continuation-in-part of application No. 11/089,400, filed on Mar. 24, 2005, now abandoned.
Application No. 11/669,635 is a continuation-in-part of application No. 11/089,400, filed on Mar. 24, 2005, now abandoned.
Application No. 11/361,764 is a continuation-in-part of application No. 11/089,400, filed on Mar. 24, 2005, now abandoned.
(60) Provisional application No. 61/135,564, filed on Jul. 22, 2008.

(51) Int. Cl. G06Q 10/00; G06Q 50/00

(52) U.S. Cl. 705/3

(57) ABSTRACT

A system that creates a national health information infrastructure provides secure storage and retrieval of personal health information (PHI) while allowing health care providers to retain their preferred method of documentation (handwriting) for the majority of their documentation requirements. Unique codes associated with each handwritten document allow rapid access to the individual patient's PHI by healthcare providers. These unique codes also allow the system to associate the images of PHI documents with the individual (e.g. patient) to whom the PHI pertains.

### CROSS REFERENCE TO RELATED APPLICATION

This utility application claims priority to, is derived from and incorporates by reference provisional application Ser. No. 61/135,564 filed on Jul. 22, 2008, entitled “National Health Information Infrastructure”, and the following pending applications:

Application Ser. No. 11/669,635, filed on Jan. 31, 2007 entitled “Method Which Creates a Community-Wide Health Information Infrastructure”,

Application Ser. No. 11/361,764, filed on Feb. 24, 2006 entitled “Method and System to Facilitate Decision Point Information Flow and to Improve Compliance with a Given Standardized Vocabulary”,

Application Ser. No. 11/089,400, filed on Mar. 24, 2005 entitled “Method, Device, and Systems to Facilitate Identity Management and Bidirectional Data Flow within a Patient Electronic Record Keeping System”.

### BACKGROUND OF THE INVENTION

In a principal aspect, the present invention relates to a system for maintaining patient electronic medical records wherein the system provides the following characteristics:
a) The records are unique to individual patients setting forth and storing the data and information relevant to each patient including data and information categorized as the type which is subject to computer decision support, for example, may be analyzed in accord with an algorithm such as a program that analyzes the allergic impact of medication upon the unique patient; and further data and information that may not be analyzed or evaluated in accord with an algorithm such as general commentary regarding medical disposition observed by a medical doctor and noted in a written record.
b) The categorized information and/or data is segregated into the noted categories and independently retrievable as a complete patient record category or from one of the categories.
c) The information and data are stored in a storage device, server or the like subject to operations thereon by a processor or equivalent in a system such as an internet system or web system having at least two independent input elements and elements which enable access to stored information and data subject to access protocols or codes. The access codes may be unique for the patient and for medical practitioners evaluating or serving the patient as well as emergency responders.

The categorization of information and data may alter with time as algorithms are developed that enable management of the data or information. In the interim, a full medical record is maintained and the data or information subject to algorithmic processing is made useful to diagnose, evaluate, and project patient indications and reactions, such as medication reaction events or likelihood. The unprocessed data enables review of subjective input which has been, for example, hand written.

On Jun. 18, 2008, the New England Journal of Medicine published the results of a survey of ambulatory care physicians. Conducted in 2007-8, the survey revealed that 13% of the respondents had a basic electronic medical record (EMR) system, and 4% of respondents had a fully functional electronic medical record system. Based on this information, it is clear that many physicians view an electronic medical record to be a luxury, not a necessity.

Part of the resistance of health care providers to an EMR may be the result of workflow disruptions inherent to an EMR installation. The current invention addresses these issues.

Privacy concerns affect the free flow of information in the health care industry. Patients, health care providers, and vendors working in the industry are all generally expected to limit access to protected health information to those with a need to know it.

Medication management associated with health care today has multiple problematic aspects. Among these are

1) currently there are at least three sources of varying reliability and agreement, for medication lists:
the patient
the prescriptions various providers write
the medication history (generally based on claims data)

2) currently, health care providers prefer to use a paper form to write prescriptions, such that electronic prescribing solutions compete, chiefly, with paper prescription pads which are readily available and quick

3) health care providers generally embrace change reluctantly, one reason that e-prescribing and electronic medical records (EMR's) have not been widely adopted across the industry

4) The Joint Commission, a national accreditation body, has embraced medication reconciliation across the continuum of care—effectively, sharing of the patient's medication list by all health care providers who participate in a unique patient's care—as a worthwhile safety initiative by all health care providers.

### SUMMARY OF THE INVENTION

Briefly, the present invention involves the use of a method to accumulate, store, and retrieve personal health information (PHI) which involves an approach to the creation, storage, and amendment of PHI and establishes a network effect which is desirable to create a national health information infrastructure. “Network effect” is the phenomenon whereby the value of a service increases with the number of users of the service, resulting in the creation of a positive feed-back loop and, ultimately, a continuously increasing number of users.

To achieve many of the benefits associated with an electronic medical record system, some elements of the medical data stored must be machine-readable. In other words, computerized algorithms exist which enable automated quality assurance of various healthcare related processes; most of these algorithms require the entry of machine-readable input. However, much of the documentation effort of a health care provider does not need to be machine-readable in order to achieve these aforementioned benefits. Unlike previous approaches to a national health information infrastructure, the approach, according to the current invention, allows health care providers to use handwritten documentation in many cases while requiring the generation of machinereadable language for certain required elements of PHI documentation.

In a principle aspect, the present invention relates to the field of medicine, specifically, the creation of a network of health care providers, patients, and pharmacists who may be otherwise unrelated but who are working together to exchange information via the common (inventive) platform to create the secure exchange of personal health information (PHI) between health care providers and/or pharmacists
1) in a manner which allows the patient to generally control access to his respective PHI,
2) in a manner which allows the prescribing practitioner to communicate PHI to the next healthcare provider caring for the patient, particularly when the healthcare provider may be unaware which health care provider will next care for the patient,
3) in a manner that allows the health care provider the option of handwriting the majority of the documentation required for a given visit,
4) in a manner that creates an economic incentive for health care providers to participate in the national health information infrastructure, while creating a net savings across society.

While the disclosed embodiment of the current invention involves use in the medical industry, with minimal modification the inventive system is readily adaptable to the creation of mixed format (both machine-readable and non-readable images) storage and retrieval systems for other industries; these uses are incorporated into this application by reference.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a schematic flow chart depicting an embodiment of the record keeping system;

FIG. 2 is a flow chart depicting in more detail the embodiment of FIG. 1;

FIG. 3 comprises examples of forms used in the practice of the system of FIG. 1;

FIG. 4 comprises a further example of a form used in the practice of the system of FIG. 1;

FIG. 5 comprises another form used in the practice of the system; and

FIG. 6 is a chart illustrating security codes used in the system.

### DESCRIPTION OF AN EMBODIMENT OF THE INVENTION

In the description, various terms are utilized in their normal sense and context and include the following additional features with respect thereto:

“User” will mean an individual who desires to have access to the data contained in a database, whether to view it only or to view and change it.

“Unique identifying number” means a character sequence which has been uniquely assigned to a specific user—utilizing an association assigned by the system upon first use of the system by that user.

“One-time Code” and/or “Unique Code” will mean a unique character sequence which has been generated using a random-number generator (which also confirms that the sequence has not been previously used), then assigned a relationship with another defined set of information contained in a database. This code may be displayed and/or printed in plain (human-readable) format, or other suitable formats, e.g. bar codes.

“Client” means a user's computer, as distinguished from a central server to which it may be connected over a network.

“Central Server” means a computer which is connected to a network, and which is used as a central repository for the storage and retrieval of electronic information. A central server also runs applications, generally written in machine-interpretable code, which define the ways the central server will interact with information submitted to it over a network.

“Network” means any means of electronic data transfer communication between servers, terminals and hardware including the World Wide Web, wireless and wired internal dedicated networks and external networks.

“Password” means a character sequence which is meant to be known to a specific user and generally not known by others.

The system generally includes discrete hardware elements, associated with a network which connects the necessary computers/servers, and the paper-based output of a printer associated with the system.

1) a client computer

2) a central server (computer)

3) a network that connects the two

4) a printer

5) a scanner or fax machine capable of transmitting an image to the central server

6) a variety of patient documentation forms that is the (paper-based) tangible output of a printer according to the inventive system.

The system causes a unique code to be printed on each patient documentation form generated by the system. When the image of the document is sent to the central server using the scanner or fax machine, this unique code is used by the central server to correctly create an association between the document image and the patient account.

On this basic framework, one embodiment of the inventive system involves an application which runs on the central server, a database on the central server used to store and retrieve information used by the application, and software that creates a user interface on the client computer(s). In one embodiment of the current invention, the user interface on the client computer is created using software that runs in the context of an internet browser. This application creates role-based access to personal health information (PHI)—that is, access to the application is controlled (e.g. using username and password access control), and the user interface and level of access to the PHI is controlled by the application, respective to the role of the user.

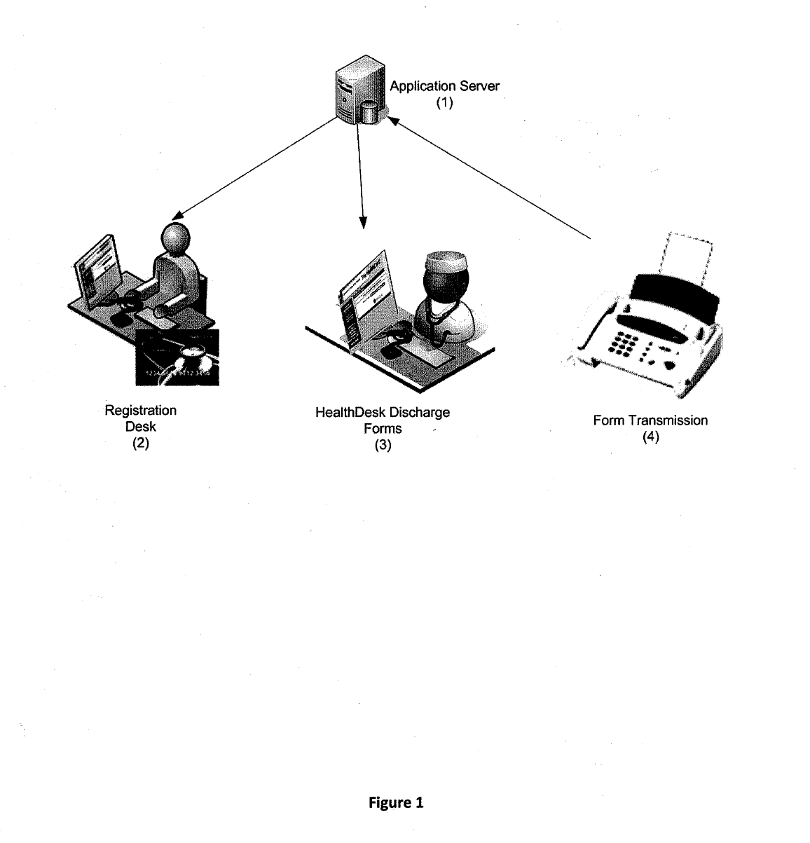

FIG. 1 is an overview of the inventive system. A central server (1) runs the computer application that allows the storage, and retrieval, of Personal Health Information. This PHI is stored respective to an individual. Each individual user is assigned an account number. Using the user-interfaces respective to various roles, the PHI can be retrieved for display and amendment, as shown at the registration desk (2). A machine-readable unique code is generated and printed on each paper-based document generated by the system. Healthcare providers write on the paper-based documents (e.g. generate new PHI); the images of these documents are then transmitted back to the central server by an imaging machine (4). The central server uses the unique code associated with each document to cause an association between the document images and the individual patient whose information the documents contain. The healthcare providers also use the system to generate new prescriptions and discharge instructions (3).

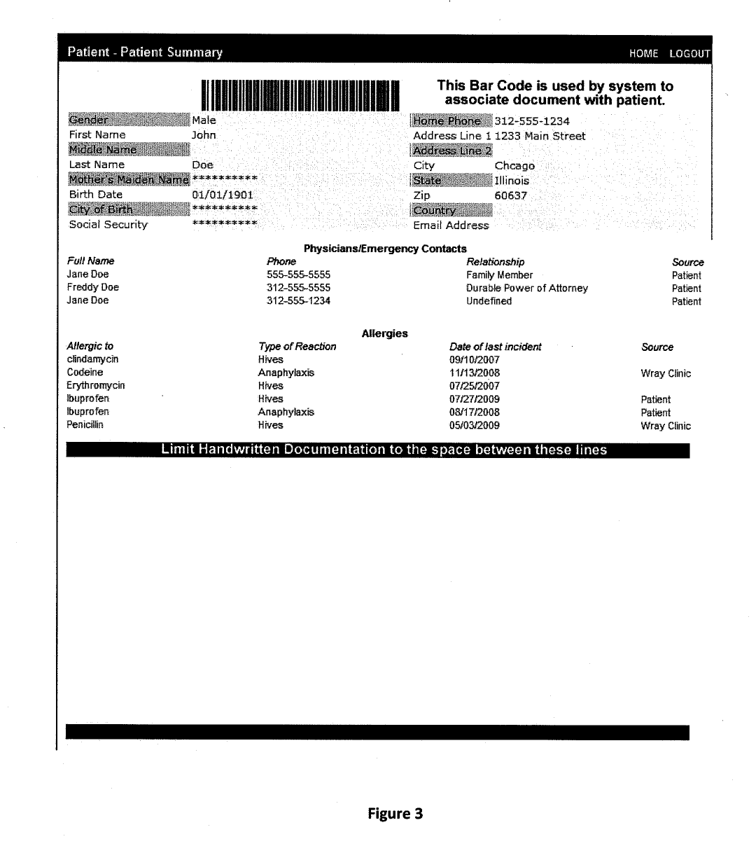

On each of these figures (FIGS. 3, 4, and 5) the unique code assigned to the document is illustrated by a bar code displayed at the top left of each printed page. The bar code is used for illustrative purposes; any machine-readable printed characters can be used.

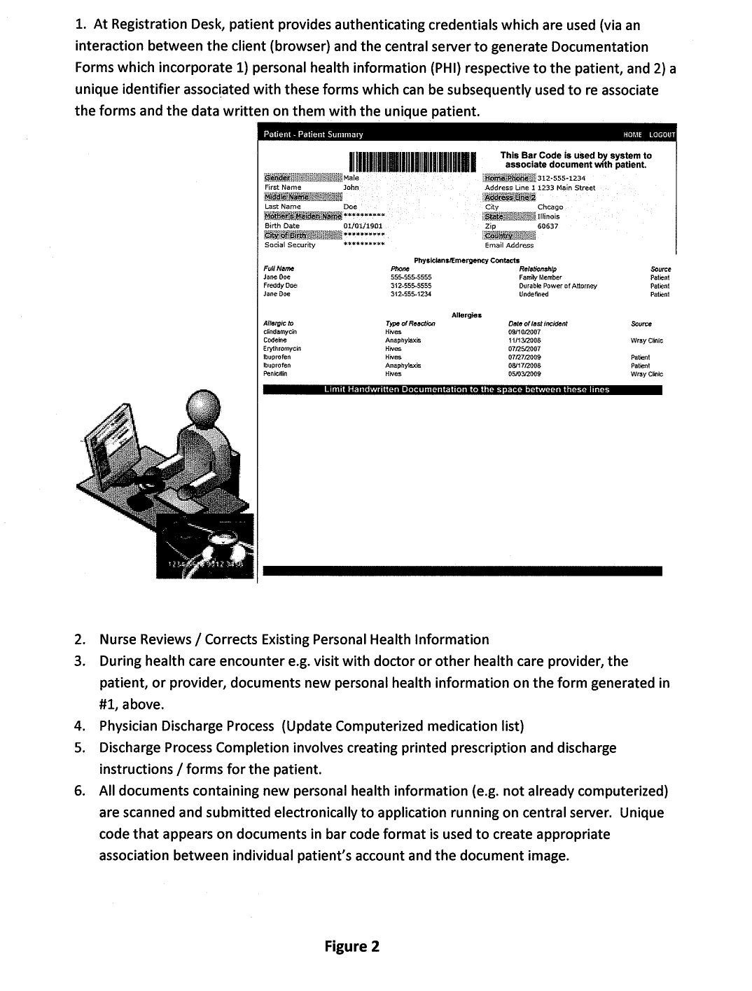

FIG. 2 is a schematic flow chart of a healthcare provider's workflow, in one embodiment of the invention. In this overview, six steps are illustrated;

1) on the client computer, using an access-controlled web page that interacts with an application running on the central server (i.e. correct username and password required for access), a patient's Personal Health Information is retrieved and printed on the local printer attached to the client computer, in a specific format called the “HealthDesk Documentation Forms.” These forms are illustrated in FIG. 3.

2) A nurse reviews these “HealthDesk Documentation Forms” with the patient, updating them as required (generally using a pen with the paper-based forms).

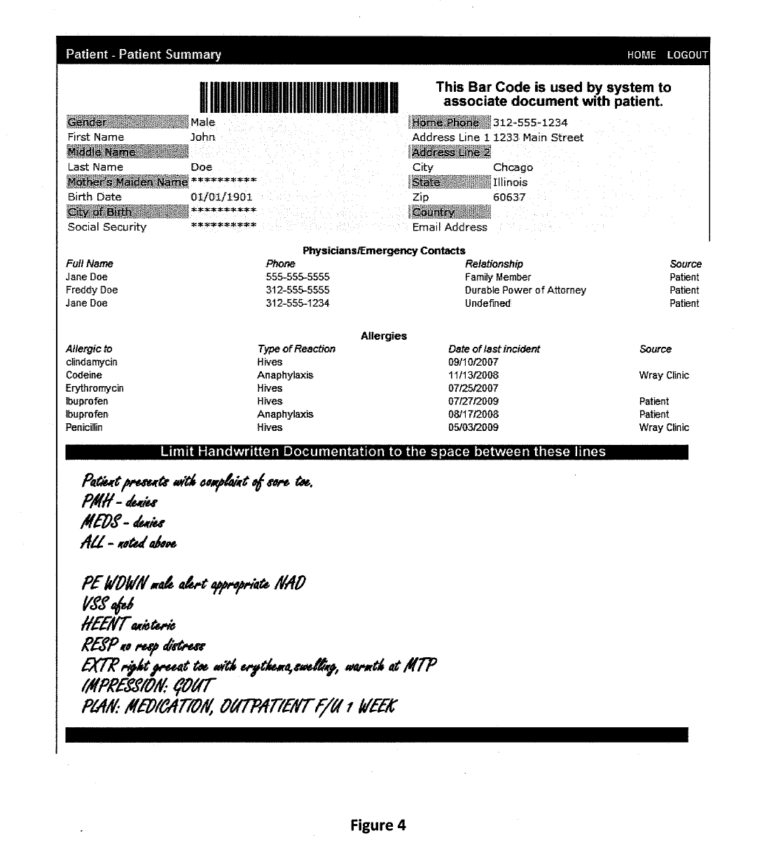

3) A healthcare encounter occurs; the healthcare provider users pen to document the encounter. FIG. 4 illustrates a completed HealthDesk Documentation Form.

4) The healthcare provider uses an access-controlled web page to access the patient's Personal Health Information, and now updates the medication list for the patient; the application tracks changes to the medication list (new medications, discontinued medications).

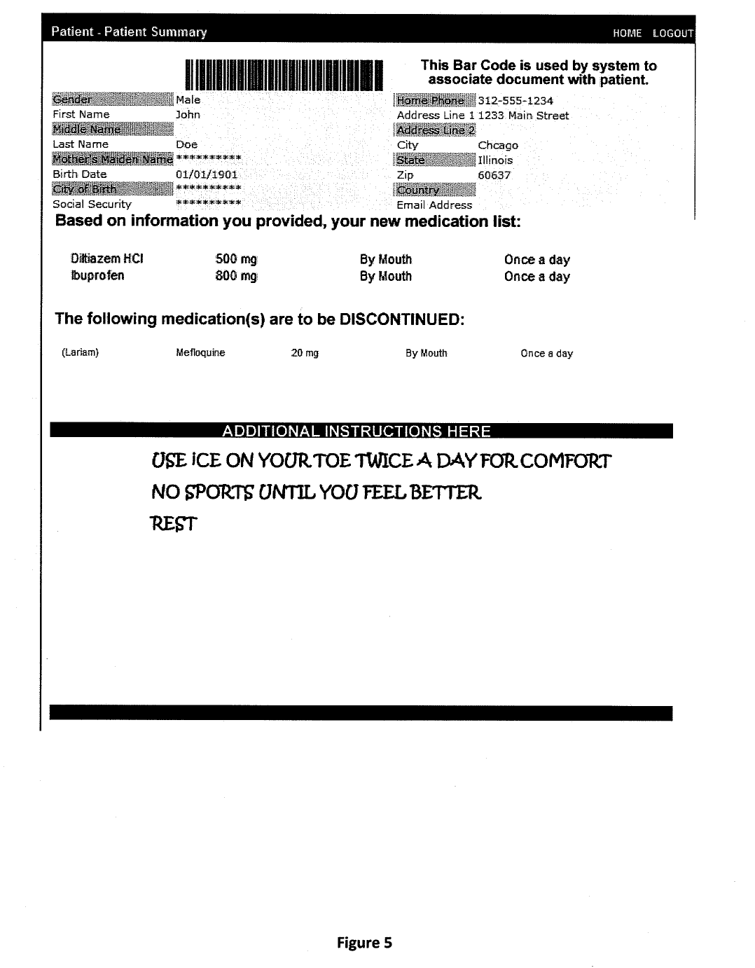

5) A physician or nurse uses an access-controlled web page to access the patient's Personal Health Information, and now prints new prescriptions along with discharge instructions (“HealthDesk Discharge Forms”) which have been personalized for the individual patient. These discharge instructions are illustrated in FIG. 5.

6) The paper forms associated with step 3 are scanned using a scanning device and/or a fax machine; these images are transmitted to the central server. Using the unique code that is displayed on each image, the central server causes a correct association between the individual patient and the document image.

FIG. 3 is an illustration of (two) printed pages that are generated for an individual patient at the registration desk. The first page contains (machine-readable) data that has been previously entered by the patient or previous health care providers. It also incorporates a paper-based method for the patient to record additional information pertinent to this specific health care encounter. The second page contains space that is intentionally left blank to provide room for the healthcare provider to accomplish handwritten documentation of the healthcare encounter. A bar code, highlighted in yellow at the top-left corner of each page, is illustrative of the unique code that has been assigned to these paper-based documents and stored respective to the patient. This unique code will be used to associate the image of the document with the individual patient to whom the information belongs, after the image is transmitted to the central server using a scanning device.

FIG. 4 is an illustration of a HealthDesk Documentation Form that has been completed by a healthcare provider.

FIG. 5 is an illustration of a HealthDesk Discharge Form that has been generated for an individual patient in response to a healthcare provider's interactions with the inventive system. To create this form, the patient's PHI is rapidly retrieved and appropriately amended by the health care provider, by submitting to the inventive application the unique code printed on the HealthDesk Documentation Form as an accelerated means of retrieving PHI respective to the appropriate patient. The Discharge Form, and associated prescriptions, are generated and printed by the inventive system; these forms and prescriptions reflect the changes initiated by the health care provider.

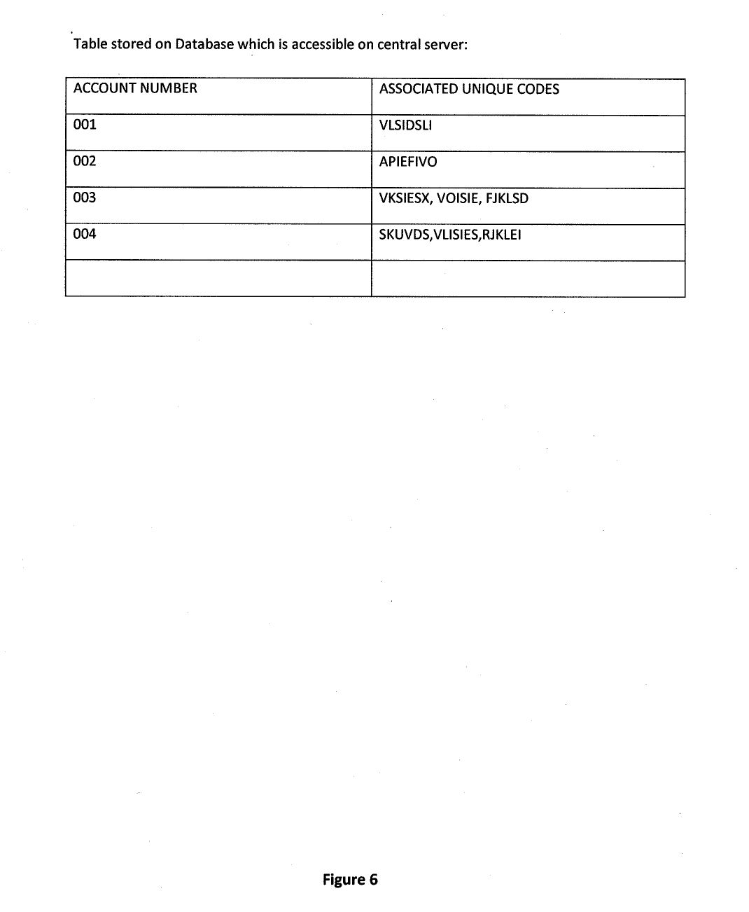

FIG. 6 is illustrative of the unique codes that are generated by the system and stored in a manner that associates the unique codes with an individual account number (e.g. an individual patient). Using these associations, documents bearing these unique codes can be correctly associated with respective individuals.

Accordingly several advantages and objects of the invention include:

1) The storage and retrieval of personal health information (PHI) using a novel and unique method with the following characteristics

2) Patient-centric, e.g. patient-controlled access to the information

3) Nearly instantaneous retrieval of PHI respective to a specific individual, at various stages in the health care workflow

4) Accommodation of health care provider's preferred documentation method (handwriting) for the majority of documentation requirements

5) Creation of machine-readable documentation (e.g. medication list) where machine-readable documentation is essential for the realization of specific benefits associated with an electronic medical record system, e.g. drug-drug interaction warnings, drug-allergy warnings, dose checking

6) Creation of a network effect that causes an increased incentive for individual physicians to adopt the system. This is created due to a variety of factors, including:
i. Any document stored in the system becomes retrievable by any other physician using the system, so the value of the system increases over time (with the value of the information stored in the system).
ii. Patients see value in participating in the system due to the likelihood of improved medication safety and perhaps medical safety in general.
iii. Healthcare providers see value in participating in the system due to the likelihood of improved medication safety and perhaps medical safety in general.
iv. Healthcare providers see value in participating in the system specifically because their patients desire them to participate.
v. The system can be extended to incorporate financial incentives for participation, e.g. participating physicians receive compensation for patient care in an accelerated manner compared to non-participating physicians.
vi. Inherent to the design of the system are features that make fraudulent patient-visit claims more difficult than other systems. For example, no PHI can be retrieved, and therefore no claim for compensation could be filed using the system, without a valid account number or PIN from the patient.

While an example of the invention has been set forth, the invention is limited only by the following claim or claims.

What is claimed is:

1. A medical health record system for maintaining information and data unique to multiple individual patients sourced from multiple independent sources comprising:
a central server;
at least two independent input devices for transmitting input data and information;
a network connecting the input devices to the server for transmission and storage of data and information, said data and information including an identification code unique to the source of the data and information, and an identification code unique to each individual patient; and
a processor in the network capable of discriminating said input data and information for storage and retrieval on the basis of a hierarchy comprising:
a) the source of the data and information
b) the individual correlated to the data and information
c) data and information capable of processing by a machine algorithm and
d) data and information not capable or processing by a machine algorithm;
said processor further capable of initiating and maintaining storage and algorithmic processing of categories a), b) and c) of the data and information, enabling access to the data and information in accord with said hierarchy.

2. The system of claim 1 wherein the data and information of category d) is not original machine authored.

3. A method of established a medical health record system comprise, the steps of processing data and information with the system of claim 1.
